(19) United States
(12) Patent Application Publication
(10) Pub. No.: US 2020/0062941 A1
(43) Pub. Date: Feb. 27, 2020

(54) POLYPROPYLENE RESIN COMPOSITION AND MOLDED PRODUCT THEREOF

(71) Applicants: HYUNDAI MOTOR COMPANY, Seoul (KR); KIA MOTORS CORPORATION, Seoul (KR); LG Hausys, Ltd., Seoul (KR); LG CHEM, LTD., Seoul (KR)

(72) Inventors: Chun Ho PARK, Cheongju-si (KR); Ki Hyun SUNG, Ulsan (KR); Soo Min LEE, Iksan-si (KR); Jae Jung YOO, Daejeon (KR); Hyun Kyung KIM, Hwaseong-si (KR); Hee Joon LEE, Seoul (KR)

(21) Appl. No.: 16/113,785

(22) Filed: Aug. 27, 2018

(51) Int. Cl. C08L 23/14

(52) U.S. Cl. CPC C08L 23/142; C08L 2205/025

(57) ABSTRACT

A polypropylene resin composition includes a polypropylene resin having a melting index of 80 g/10 min to 95 g/10 min measured under a temperature of 230° C. and a load of 2.16 kg; a thermoplastic elastomer; and a needle-shaped inorganic filler having an aspect ratio of 5 to 10.

### TECHNICAL FIELD

The present disclosure relates to a polypropylene resin composition and a molded product thereof.

### BACKGROUND ART

In the field of automobiles and electronics, demands for resin compositions having low specific gravity have recently increased. For example, in the field of automobiles, weight lightening of an automobile may be accomplished when manufacturing an automobile using a resin composition having low specific gravity. With the weight lightening of an automobile, engine efficiency may be maximized by increasing accelerating force and braking force that are basic performance, and effects of mitigating burdens imposed on tires, a brake and a suspension and fatigue of a driver may be obtained. In addition, superior accelerating performance and exercise performance may be secured compared to a heavy vehicle since a weight ratio to bear per horsepower decreases even with a relatively small output.

However, in order for a resin having low specific gravity to be commercialized as an actual product, mechanical strength and processability need to be maintained at a certain level or higher. For this, methods of strengthening mechanical properties of a polyolefin resin by mixing and stirring an inorganic filler such as talc or an impact modifier such as rubber with the polyolefin resin that is general-purpose plastics having excellent chemical resistance and ready moldability have been studied.

Attempts to achieve weight lightening by significantly reducing a product thickness have been recently made, and when a product is manufactured to have such a small thickness, additives are damaged in the product causing a limit in the strength enhancement of the product, and problems such as appearance deformation of the product have occurred based on the additive introduced.

Accordingly, development of a resin composition capable of being used as an automotive interior or exterior material by having proper level or higher processability and excellent mechanical properties while maintaining low specific gravity even when used in a molded product having a small thickness has been required.

### SUMMARY

The present disclosure is directed to providing a polypropylene resin composition capable of providing, while maintaining low specific gravity, excellent processability, high impact strength and flexural modulus at the same time even when used in a molded product having a small thickness.

According to an exemplary embodiment of the present disclosure, a polypropylene resin composition includes: a polypropylene resin having a melting index of 80 g/10 min to 95 g/10 min measured under a temperature of 230° C. and a load of 2.16 kg; a thermoplastic elastomer; and a needle-shaped inorganic filler having an aspect ratio of 5 to 10.

According to another exemplary embodiment of the present disclosure, a molded product includes an injection product of the polypropylene resin composition.

The polypropylene resin composition is capable of providing, while maintaining low specific gravity, excellent processability, high impact strength and flexural modulus at the same time even when used in a molded product having a small thickness.

### DETAILED DESCRIPTION

Advantages, characteristics, and methods of accomplishing the same of the present disclosure may be more readily understood with reference to embodiments described below. However, the present disclosure is not to be construed as being limited to the embodiments disclosed below, and may be embodied in many different forms. The embodiments are provided so that the disclosure of the present disclosure is complete and fully convey the scope of the invention to those skilled in the art, and the present disclosure is only defined by the scope of the appended claims.

One embodiment of the present disclosure provides a polypropylene resin composition including a polypropylene resin having: a melting index of 80 g/10 min to 95 g/10 min measured under a temperature of 230° C. and a load of 2.16 kg; a thermoplastic elastomer; and a needle-shaped inorganic filler having an aspect ratio, which is represented by the following Equation 1, of 5 to 10.

Aspect ratio=average length/average diameter [Equation 1]

The polypropylene resin composition appropriately includes a polypropylene resin, a thermoplastic elastomer and an inorganic filler, and is capable of increasing polypropylene resin crystallinity and providing excellent mechanical strength and impact resistance together with high fluidity. Accordingly, excellent mechanical properties may be provided using the composition even when manufacturing a molded product having a small thickness.

The polypropylene resin composition includes a polypropylene resin. The polypropylene resin may include a propylene homopolymer, a copolymer of propylene and ethylene or an olefin-based monomer having 4 to 10 carbon atoms, a block copolymer of polypropylene and ethylene-propylene rubber, or a mixture thereof.

Specifically, the polypropylene resin may include an ethylene-propylene copolymer. The content of the ethylene repeating unit included in the ethylene-propylene copolymer may be from approximately 3% by weight to approximately 10% by weight. The ethylene-propylene copolymer includes a relatively small amount of ethylene to increase polypropylene resin crystallinity and enhance strength and impact resistance of the resin composition including the polypropylene resin.

The polypropylene resin has a melting index of approximately 80 g/10 min to approximately 95 g/10 min measured under a temperature of 230° C. and a load of 2.16 kg. By including the polypropylene resin having a melting index in the above-mentioned range, the polypropylene resin composition may provide enhanced moldability and appearance characteristics, and, at the same time, may provide excellent mechanical properties. Specifically, when the melting index of the polypropylene resin is less than the above-mentioned range, processability may decline by reducing flowability of the resin when injection molding, and when the melting index of the polypropylene resin is greater than the above-mentioned range, strength and impact resistance of the polypropylene resin composition including the polypropylene resin may decrease as the strength and impact resistance balance of the injection product decreases.

The polypropylene resin composition may include the polypropylene resin in approximately 40% by weight to approximately 90% by weight. When the polypropylene resin content is less than the above-mentioned range, the amount of the inorganic filler used relatively increases causing deformation in the product appearances when molding, and when the polypropylene resin content is greater than the above-mentioned range, effects of enhancing strength and impact resistance obtained by the inorganic filler addition may be insignificant.

The polypropylene resin may have a weight average molecular weight of approximately 50,000 g/mol to approximately 500,000 g/mol. When the weight average molecular weight of the polypropylene resin is less than the above-mentioned range, flowability may become favorable, however, mechanical properties, that is, impact strength and flexural modulus, may decline. When the weight average molecular weight is greater than the above-mentioned range, mechanical properties may be enhanced, however, flowability may decrease lowering processability, and as a result, manufacturing a molded product having a small thickness may be difficult.

The polypropylene resin composition includes a thermoplastic elastomer, may provide excellent impact strength and heat resistance, and may exhibit excellent injection moldability.

The thermoplastic elastomer may include a block copolymer of ethylene and α-olefin having 4 to 30 carbon atoms. The α-olefin having 4 to 30 carbon atoms may be an α-olefin compound such as 1-butene, 1-pentene, 4-methyl-1-pentene, 1-hexene, 1-heptene, 1-octene, 1-decene, 1-undecene, 1-dodecene, 1-tetradecene, 1-hexadecene or 1-eicosene.

The block copolymer may include the ethylene and the α-olefin having 4 to 30 carbon atoms in a molar number of 6:4 to 7:3.

The block copolymer may include one selected from the group consisting of an ethylene-1-octene block copolymer, an ethylene-1-butene block copolymer and combinations thereof. The ethylene-1-octene block copolymer may have a melting index of approximately 5 g/10 min to approximately 10 g/10 min measured under a temperature of 190° C. and a load of 2.16 kg, and the ethylene-1-butene block copolymer may have a melting index of approximately 0.5 g/10 min to approximately 3 g/10 min measured under a temperature of 190° C. and a load of 2.16 kg.

The thermoplastic elastomer may have a weight average molecular weight of approximately 50,000 g/mol to approximately 180,000 g/mol. By having a weight average molecular weight in the above-mentioned range, the thermoplastic elastomer has excellent dimensional stability, and may supplement weaknesses of the polypropylene resin with high impact strength properties. Accordingly, the molded product having a small thickness manufactured from the polypropylene resin composition including the thermoplastic elastomer may have high impact strength and dimensional stability.

The thermoplastic elastomer may have a melting index of approximately 0.5 g/10 min to approximately 10 g/10 min measured under a temperature of 190° C. and a load of 2.16 kg. The thermoplastic elastomer may provide excellent heat resistance, impact strength and flexural modulus, and may exhibit excellent injection moldability.

In addition, the thermoplastic elastomer may have specific gravity of approximately 0.86 g/cm³ to approximately 0.87 g/cm³, and thereby the thermoplastic elastomer may provide a resin composition for automotive interior and exterior materials having low specific gravity.

The thermoplastic elastomer may be included in a content of approximately 17 parts by weight to approximately 50 parts by weight with respect to 100 parts by weight of the polypropylene resin. Specifically, when the thermoplastic elastomer content is less than the above-mentioned range, impact strength may decrease, and when the content is greater than the above-mentioned range, flowability decreases, dispersibility decreases, and flexural properties may decline.

The polypropylene resin composition may provide enhanced mechanical strength by including a needle-shaped inorganic filler having an aspect ratio of approximately 5 to approximately 10 represented by the following Equation 1. Accordingly, the molded product manufactured from the polypropylene resin composition including the inorganic filler exhibits excellent mechanical properties even with a small thickness, and appearance deformation may not occur.

Aspect ratio=average length/average diameter [Equation 1]

The inorganic filler has a needle-shaped structure, and may have an average diameter of approximately 3 μm to approximately 20 μm, and an aspect ratio of approximately 5 to approximately 10. By the inorganic filler having an aspect ratio in the above-mentioned range with a needle-shaped structure, significantly enhanced strength is provided, and a decrease in the melting index of the polypropylene resin composition including the same may be prevented. Specifically, when the aspect ratio of the inorganic filler is less than the above-mentioned range, strength and impact reinforcing effect are significantly reduced under the same weight, and when the aspect ratio of the inorganic filler is greater than the above-mentioned range, the inorganic filler may be damaged by poor dispersion of the inorganic filler and a pressure caused by extrusion or injection of the composition including the same, and as a result, expected effects may be low considering an increase in the costs since properties may decline.

The needle-shaped inorganic filler may include Wallastonite or whisker. For example, the inorganic filler may be Wallastonite having specific gravity of 2.7.

The polypropylene resin composition may further include a plate-shaped inorganic filler having an average diameter of approximately 1 μm to approximately 8 μm together with the needle-shaped inorganic filler, and may provide dimensional stability as well as excellent mechanical properties.

The polypropylene resin composition may further include a plate-shaped inorganic filler having an average diameter of approximately 1 μm to approximately 8 μm. Specifically, when the average diameter of the plate-shaped inorganic filler is less than the above-mentioned range, strength decreases, and when the average diameter is greater than the above-mentioned range, impact strength significantly decreases, and properties may decline due to breakage or an appearance may be deformed when used in a molded product having a small thickness. The plate-shaped inorganic filler may be talc having specific gravity of 2.7.

The inorganic filler may be included in a content of approximately 18 parts by weight to approximately 75 parts by weight with respect to 100 parts by weight of the polypropylene resin. Specifically, when the inorganic filler content is less than the above-mentioned range, enhanced mechanical properties may not be obtained, and when the content is greater than above-mentioned range, processability and appearance characteristics of the polypropylene resin composition may decline.

The polypropylene resin composition may further include one additive selected from the group consisting of an antioxidant, a UV stabilizer, a slip agent, a compatibilizer, a coupling agent and combinations thereof.

The antioxidant may be one selected from the group consisting of phenol-based antioxidants, phosphite-based antioxidant, thiodipropionate and combinations thereof.

The UV stabilizer has properties of preventing aging caused by ultraviolet rays by being included in the polypropylene resin composition, and the UV stabilizer may be one selected from the group consisting of amine-based, benzotriazole-based and combinations thereof.

The slip agent improves scratch resistance by providing a slip property on a surface of the molded product, an injection product of the polypropylene resin composition, and may be one selected from the group consisting of siloxane-based slip agents, amide-based slip agents and combinations thereof.

The compatibilizer is a polyolefin-based compatibilizer, and may increase compatibility between resins included in the polypropylene resin composition such as the propylene homopolymer.

The compatibilizer enhances interfacial adhesive strength and dispersion efficiency between resins included in the polypropylene resin composition, and thereby may enhance excellent mechanical properties, dimensional stability and surface qualities for the molded product, an injection product of the composition.

Specifically, saturated block copolymers including styrene-based may be used as the polyolefin-based compatibilizer.

The coupling agent enhances compatibility between the inorganic filler and the resin included in the polypropylene resin composition, and thereby the coupling agent may provide excellent mechanical strength and impact resistance by enhancing the degree of dispersion through increasing compatibility, and may provide dimensional stability at the same time.

Specifically, the coupling agent is a modified polypropylene resin including a reactive group having reactivity with the inorganic filler on the main chain or at the end of the polypropylene, and examples of the reactive group may include maleic acid, maleic anhydride, carboxylic acid, a hydroxyl group, vinyl acetate, glycidyl methacrylate, vinyl oxazoline, acrylic acid and the like.

Another embodiment of the present disclosure provides a molded product including an injection product of the polypropylene resin composition. The molded product includes an injection product of the polypropylene resin composition described above, and may have excellent processability and excellent mechanical properties, that is, high impact strength and flexural modulus while maintaining low specific gravity even when used in a molded product having a small thickness. Matters relating to the polypropylene resin composition are as described above.

The molded product may be used for automotive exterior materials such as a bumper, a spoiler, a side visor, a cowl vent grill, a radiator grill, a side molding and an end panel garnish, or for automotive interior materials such as an instrument panel, a ceiling, a door, a seat and a trunk room.

Specifically, by having a small thickness, the molded product may have excellent mechanical strength and impact resistance as well as the weight being lighter. For example, the molded product may exhibit excellent mechanical strength and impact resistance even at a thickness of less than approximately 2.5 mm. The molded product may have a thickness of approximately 2.0 mm to approximately 2.2 mm. Accordingly, the molded product may be suitable to be used as an automotive interior or exterior material such as a bumper.

The molded product may have flexural modulus of approximately 2500 MPa or greater, or approximately 2500 MPa to approximately 3000 MPa by ASTM D790. The flexural modulus means a ratio of stress and deformation in the elastic limit when applying a flexural load to a polymer. The molded product is manufactured from the polypropylene resin composition described above, and when having flexural modulus in less than the above-mentioned range, the molded product having a thickness of less than approximately 2.5 mm may not endure an external impact when used in a bumper and the like, and may not be used as an automotive interior or exterior material.

In addition, the molded product may have IZOD impact strength of 290 J/m or greater, or 290 J/m to 350 J/m by ASTM D256. The impact strength represents strength against resistance appearing when an object is subject to impact, and is expressed as total energy consumed when a sample is broken or as breaking energy absorbed per unit length of a sample. The molded product is manufactured from the polypropylene resin composition described above, and when having flexural modulus in less than the above-mentioned range, the molded product having a thickness of less than approximately 2.5 mm may not endure an external impact when used in a bumper and the like, and may not be used as an automotive interior or exterior material.

Hereinafter, specific examples of the present disclosure will be described. However, the examples described below are for specifically illustrating or describing the present disclosure only, and the present disclosure is not limited thereto.

### EXAMPLE AND COMPARATIVE EXAMPLE

### Example 1

Approximately 59.9% by weight of an ethylene-propylene copolymer resin having an ethylene content of approximately 5% by weight to approximately 9% by weight, and a melting index of 90 g/10 min measured under a temperature of 230° C. and a load of 2.16 kg, an ethylene-1-octene copolymer having a melting index of 7.5 g/10 min measured under a temperature of 190° C. and a load of 2.16 kg and specific gravity of 0.865/cm³, and needle-shaped Wallastonite having an average diameter of 8 μm, an aspect ratio of 5 and specific gravity of 2.7 g/cm³ were mixed.

Herein, the ethylene-1-octene copolymer was included in a content of approximately 33.7 parts by weight with respect to 100 parts by weight of the ethylene-propylene copolymer resin, and the Wallastonite was mixed in a content of approximately 33.7 parts by weight with respect to 100 parts by weight of the ethylene-propylene copolymer resin to prepare a polypropylene resin composition.

The polypropylene resin composition was extruded under a processing condition of 200° C. to 240° C. using a biaxial extruder to prepare an ultra-thin specimen having a thickness of 2.0 mm to 2.2 mm.

### Example 2

A polypropylene resin composition was prepared in the same manner as in Example 1 except that needle-shaped Wallastonite having an aspect ratio of 7 was mixed.

### Example 3

A polypropylene resin composition was prepared in the same manner as in Example 1 except that needle-shaped Wallastonite having an aspect ratio of 10 was mixed.

### Example 4

A polypropylene resin composition was prepared in the same manner as in Example 1 except that approximately 62.3% by weight of the ethylene-propylene copolymer resin and the needle-shaped Wallastonite in a content of approximately 27 parts by weight with respect to 100 parts by weight of the ethylene-propylene copolymer resin were mixed.

### Example 5

A polypropylene resin composition was prepared in the same manner as in Example 1 except that an ethylene-1-butene copolymer having a melting index of 1.5 g/10 min measured under a temperature of 190° C. and a load of 2.16 kg was mixed.

### Comparative Example 1

A polypropylene resin composition was prepared in the same manner as in Example 1 except that needle-shaped Wallastonite having an aspect ratio of 4 was mixed.

### Comparative Example 2

A polypropylene resin composition was prepared in the same manner as in Example 1 except that needle-shaped Wallastonite having an aspect ratio of 15 and plate-shaped talc were mixed.

### Comparative Example 3

A polypropylene resin composition was prepared in the same manner as in Example 1 except that an ethylene-propylene copolymer resin having an ethylene content of approximately 6% by weight to approximately 10% by weight and a melting index of 100 g/10 min measured under a temperature of 230° C. and a load of 2.16 kg was mixed instead of the ethylene-propylene copolymer resin of Example 1.

### Comparative Example 4

A polypropylene resin composition was prepared in the same manner as in Example 1 except that an ethylene-propylene copolymer resin having an ethylene content of approximately 3% by weight to approximately 7% by weight and a melting index of 110 g/10 min measured under a temperature of 230° C. and a load of 2.16 kg was mixed instead of the ethylene-propylene copolymer resin of Example 1.

### Evaluation

### Experimental Example 1: Specific Gravity

Specific gravity of each of the specimens obtained in the examples and the comparative examples was measured by ASTM D792, and the results are shown in [Table 1].

### Experimental Example 2: Melting Index (g/10 min)

A melting index of each of the polypropylene resin compositions obtained in the examples and the comparative examples was measured under 230° C. and a load of 2.16 kg according to the ASTM D1238 method, and the results are shown in [Table 1].

### Experimental Example 3: Flexural Modulus (MPa)

Flexural modulus of each of the specimens prepared in the examples and the comparative examples was measured using ASTM D790 under the condition of a 10 mm/min rate, and the results are shown in [Table 1].

### Experimental Example 4: IZOD Impact Strength (J/m)

IZOD impact strength of each of the specimens prepared in the examples and the comparative examples was measured at room temperature (23° C.) and low temperature (−30° C.) by ASTM D256, and the results are shown in [Table 1].

TABLE 1

| | Example | | | | | Comparative Example | | | |
|---|---|---|---|---|---|---|---|---|---|
| Category | 1 | 2 | 3 | 4 | 5 | 1 | 2 | 3 | 4 |
| Specific | 1.03 | 1.03 | 1.03 | 1.01 | 1.03 | 1.03 | 1.03 | 1.03 | 1.03 |
| Gravity | | | | | | | | | |
| Melting | 30 | 35 | 45 | 45 | 35 | 30 | 45 | 40 | 47 |
| Index | | | | | | | | | |
| (g/10 | | | | | | | | | |
| min) | | | | | | | | | |
| Flexural | 2500 | 2600 | 2700 | 2500 | 2700 | 1900 | 2700 | 2800 | 2900 |
| Modulus | | | | | | | | | |
| (MPa) | | | | | | | | | |
| IZOD | 290 | 300 | 320 | 300 | 350 | 230 | 250 | 200 | 150 |
| Impact | | | | | | | | | |
| Strength | | | | | | | | | |
| (J/m, | | | | | | | | | |
| 23° C.) | | | | | | | | | |
| IZOD | 33 | 35 | 37 | 37 | 40 | 30 | 30 | 25 | 22 |
| Impact | | | | | | | | | |
| Strength | | | | | | | | | |
| (J/m, | | | | | | | | | |
| −30° C.) | | | | | | | | | |

As seen in Table 1, it was seen that the examples prepared from the polypropylene resin composition including a polypropylene resin having a melting index of 80 g/10 min to 95 g/10 min; a thermoplastic elastomer; and a needle-shaped inorganic filler having an aspect ratio of 5 to 10 provided excellent processability, high impact strength and flexural modulus at the same time even when used in a molded product having a small thickness. Specifically, it was identified that, unlike the comparative examples, the examples had both flexural modulus of 2500 MPa or greater and IZOD impact strength of 290 J/m or greater.

What is claimed is:

1. A polypropylene resin composition comprising:
a polypropylene resin having a melting index of 80 g/10 min to 95 g/10 min measured under a temperature of 230° C. and a load of 2.16 kg;
a thermoplastic elastomer; and
a needle-shaped inorganic filler having an aspect ratio, which is represented by the following Equation 1, of 5 to 10:
aspect ratio=average length/average diameter. [Equation 1]

2. The polypropylene resin composition of claim 1, wherein the polypropylene resin includes an ethylene-propylene copolymer.

3. The polypropylene resin composition of claim 2, wherein the ethylene-propylene copolymer includes 3% by weight to 10% by weight of ethylene based on a total weight of the ethylene-propylene copolymer.

4. The polypropylene resin composition of claim 1, comprising the polypropylene resin in 40% by weight to 90% by weight based on a total weight of the polypropylene resin composition.

5. The polypropylene resin composition of claim 1, wherein the thermoplastic elastomer has a melting index of 0.5 g/10 min to 10 g/10 min measured under a temperature of 190° C. and a load of 2.16 kg.

6. The polypropylene resin composition of claim 1, wherein the thermoplastic elastomer includes a block copolymer of ethylene and α-olefin having 4 to 30 carbon atoms.

7. The polypropylene resin composition of claim 6, wherein a molar ratio of the ethylene and the α-olefin having 4 to 30 carbon atoms is from 6:4 to 7:3.

7. The polypropylene resin composition of claim 1, comprising the thermoplastic elastomer in 17 parts by weight to 50 parts by weight with respect to 100 parts by weight of the polypropylene resin.

9. The polypropylene resin composition of claim 1, wherein the inorganic filler includes one selected from the group consisting of Wallastonite, whisker, and combinations thereof.

10. The polypropylene resin composition of claim 1, further comprising a plate-shaped inorganic filler having an average diameter of 1 μm to 8 μm.

11. The polypropylene resin composition of claim 1, comprising the inorganic filler in 18 parts by weight to 75 parts by weight with respect to 100 parts by weight of the polypropylene resin.

12. The polypropylene resin composition of claim 1, further comprising one additive selected from the group consisting of an antioxidant, a UV stabilizer, a slip agent, a compatibilizer, a coupling agent and combinations thereof.

13. A molded product comprising the polypropylene resin composition of claim 1.

14. The molded product of claim 13, wherein an automotive interior or exterior material includes the molded product.

15. The molded product of claim 13, which has a thickness of less than 2.5 mm.

16. The molded product of claim 13, which has flexural modulus of 2500 MPa or greater by ASTM D790.

17. The molded product of claim 13, which has IZOD impact strength of 290 J/m or greater by ASTM D256.
